(19) United States
(12) Patent Application Publication
(10) Pub. No.: US 2008/0022397 A1
(43) Pub. Date: Jan. 24, 2008

(54) SYSTEMS AND METHODS FOR MANAGING NETWORK VULNERABILITY

(75) Inventor: Tung-Sheng Cheng, Taichung County (TW)

Correspondence Address: THOMAS, KAYDEN, HORSTEMEYER & RISLEY LLP, 600 GALLERIA PARKWAY, 15TH FLOOR, ATLANTA, GA, 30339, US

(73) Assignee: TAIWAN SEMICONDUCTOR MANUFACTURING CO., LTD., Hsin-Chu (TW)

(21) Appl. No.: 11/423,990

(22) Filed: Jun. 14, 2006

(51) Int. Cl. H04L 9/32

(52) U.S. Cl. 726/20

(57) ABSTRACT

A system for managing network vulnerability. A monitoring device detects a network message transmitted by a network device requesting access to a network. An authentication server identifies a security feature of the network device transmitting the detected network message, applies a security rule to the network message to determine whether the security feature provides adequate protection, and if so, permits the network device to access the network.

### BACKGROUND

The present invention relates to network security and particularly to systems managing vulnerability of elements in a network system.

Millions of users connect to the Internet to conduct e-commerce transactions, perform searches for information, and/or download executable programs.

In general, the vast majority of the downloadable data from the Internet represents useful or at least non-harmful content. There exists a class of executable codes, however, which, if downloaded and executed by host computers, may wreak havoc with the operating system, hardware, or other software residing on a host computer. These executable codes are popularly known as viruses.

A failure may be caused in a network system, such as an intranet, when a device carrying a computer virus is connected thereto. This situation becomes worse when the network system may be accessed by a device without a specific detection system.

Additionally, in an advanced manufacturing system, all or part of the manufacturing equipment are capable of network connection. In this case, a harmful code such as computer virus may cause a failure in the manufacturing equipment, which in turn may cause severe damage in the manufacturing system.

### SUMMARY

The invention provides a system for managing network vulnerability, comprising a monitoring device and an authentication server. The monitoring device detects a network message transmitted by a network device requesting access to a network. The authentication server identifies a security feature of the network device transmitting the detected network message, applies a security rule to the network message to determine whether the security feature provides adequate protection, and if so, permits the network device to access the network.

Embodiments of a method of managing network vulnerability are provided. A network message transmitted from a device requesting access to a network is identified. A security feature of the device transmitting the detected network message is identified. A security rule is applied to the security feature to determine whether the security feature provides adequate protection to the device, and if so, the device is permitted to access the network. Identification and security feature records of the device are then stored for future use.

The method may take the form of program code embodied in a tangible media. When the program code is loaded into and executed by a machine, the machine becomes an apparatus for practicing the method.

### DESCRIPTION OF THE DRAWINGS

The invention can be more fully understood by reading the subsequent detailed description and examples with references made to the accompanying drawings, wherein:

FIG. 1 is a schematic view of an embodiment of a network system implementing vulnerability management; and

FIG. 2 is a flowchart of an embodiment of a network vulnerability management method.

### DETAILED DESCRIPTION

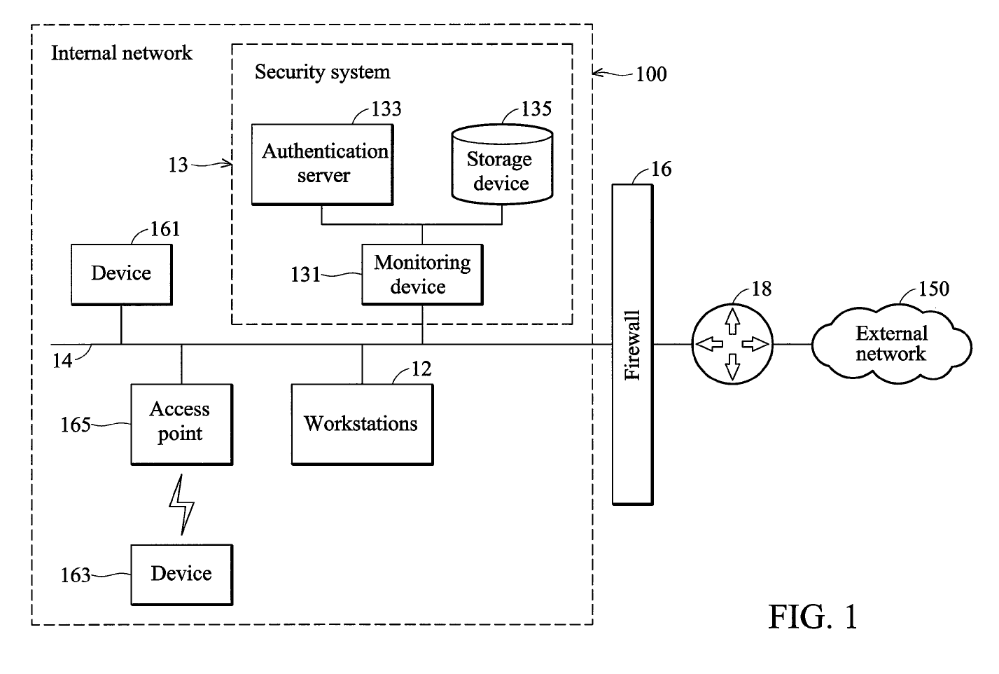

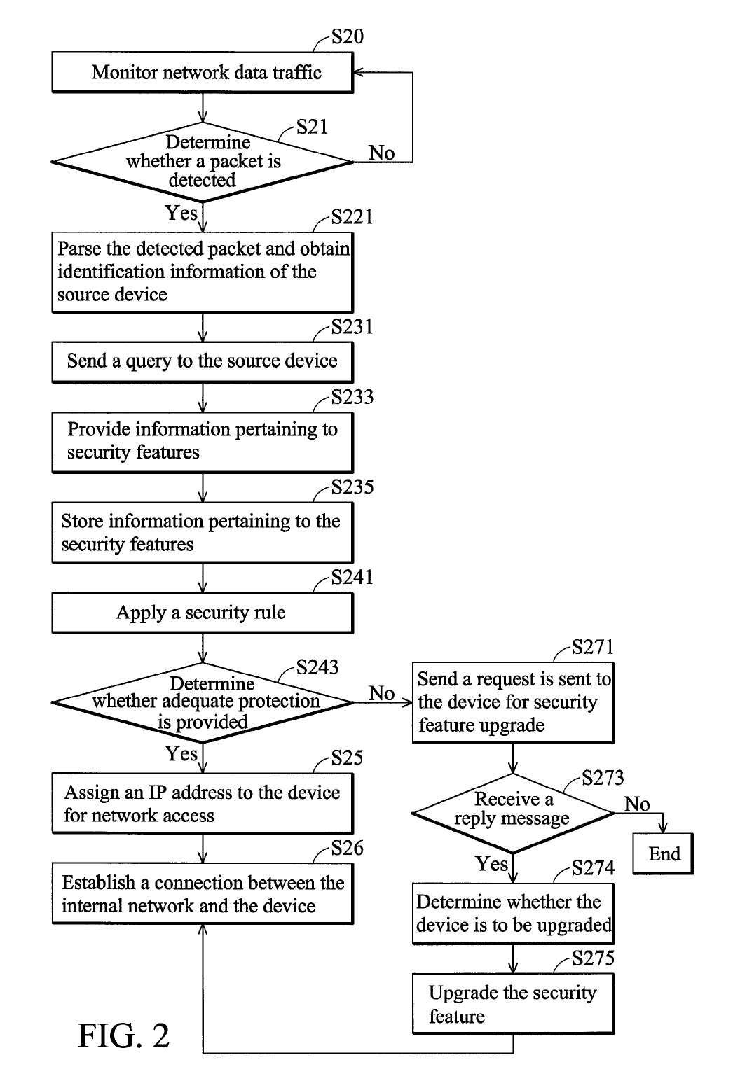

Exemplary embodiments of the invention will now be described with reference to FIGS. 1 and 2, which generally relate to vulnerability management in a local area network. While some embodiments of the invention are applied with a local area network, it is understood that other network systems may be implemented.

In the following detailed description, reference is made to the accompanying drawings which form a part hereof, and in which is shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the present invention. The following detailed description is, therefore, not to be taken in a limiting sense. The leading digit(s) of reference numbers appearing in the Figures corresponds to the Figure number, with the exception that the same reference number is used throughout to refer to an identical component which appears in multiple Figures.

FIG. 1 is a schematic view of an embodiment of a network system implementing vulnerability management. As shown, the network environment comprises devices that form an internal network 100, protection for the internal network 100, and an external network 150. The internal network 100, such as a local area network (LAN), comprises a plurality of devices coupled to a network backbone 14. Network backbone 14 may comprise, for example, an Ethernet, FDDI, token ring, or other physical media. Protection for internal network 100 can be provided by firewall 16 and a router 18 which are coupled to network backbone 14. Router 18 serves as a gateway between the internal network 100 and the external network 150. External network 150 can be, for example, the Internet or other public network. Firewall 16 can serve to limit external access to resources in internal network 100 and protect these internal resources from unauthorized use.

Internal network 100 further comprises a security system 13 coupled to network backbone 14. Although FIG. 1 displays security system 13 coupled to internal network 100 through network backbone 14, those skilled in the art may recognize that security system 13 may couple to internal network 100 in other ways, such as through another computer device. The security system 13 comprises a monitoring device 131, an authentication server 133, and a storage device 135. The monitoring device 131 receives network messages traffic on the internal network 100, and detects a network message broadcast from a device requesting to the internal network 100. The authentication server 133 identifies a security feature of the device sending the detected network message, applies a security rule to the security feature to determine whether adequate protection is provided, and if so, permits the device to access the internal network 100. When the device is permitted to access the network, the authentication server 133 assigns an Internet Protocol (IP) address to the device according to the known Dynamic Host Configuration Protocol (DHCP). The storage device 135 stores identification and security feature records of the device.

In the embodiment shown in FIG. 1, security system 13 is coupled directly to network backbone 14 “inside” internal network 100. Such a configuration is typical, for example, of an intrusion detection system. However, those skilled in the art may recognize that security system 13 may be coupled to a network in other configurations. For example, security system 13 could be incorporated into another device located on internal network 100, such as firewall 16 or router 18. Alternatively, as further shown in FIG. 1, security system 13 could be coupled outside internal network 10, such as between firewall 16 and router 18, or outside router 18. It should be understood that a different arrangement of security system 13 may affect its operation, as different arrangements expose security system 13 to different network environments.

Security system 13 may comprise, for example, software code executed on a computing device such as a LDAP, Active Directory, or RADIUS based workstation.

In operation, devices such as workstation 12 may communicate over network backbone 14. Workstations 12 may further communicate with external network 150 via network backbone 14 and router 18. As previously described, firewall 16 is intended to prevent unauthorized access from external network 150 to devices coupled to internal network 100. Firewall 16, however, may not capable of preventing the internal network 100 from virus infection caused by a device coupling directly to the internal network 100. Here, the term “virus” refers to harmful executable code.

When a device requires access to the internal network 100, the security system 13 operates to determine whether the newly added device is equipped with adequate security protection. Security system 13 accomplishes this by monitoring traffic on network backbone 14, identifying a network message broadcast from a device requesting network access, identifying a security feature of the device sending the detected network message, applying a security rule to the security feature to determine whether the security feature provides adequate protection to the device, and if so, permitting the device to access the internal network 100. Identification and security feature records of the device are then stored in the storage device 135.

The device, such as devices 161 and 163, may access the internal network 100 through a wired or wireless connection. For example, device 163 accesses internal network resources via a wireless connection through an access point 165.

The security system 13 analyzes network messages to identify potential vulnerabilities of internal network 10. For example, security system 13 could perform a rules-driven assessment on the network messages that monitoring device 131 has detected.

The processing algorithm implemented in security system 13 is detailed in the flowchart of FIG. 2.

In step S20, network data traffic is monitored. Network data traffic may comprise, for example, packets transmitted from devices coupled to the internal network 100. Each packet may be “captured” in step S20. In step S21, it is determined whether a packet comprising a request for an IP address is detected, wherein the IP address may be used by a corresponding device to access the internal network. The detected packet is parsed and identification information of the source device is obtained accordingly (step S221). The identification information may comprise the MAC address of the device. A query is then sent to the source device of the detected packet (step S231), inquiring security features of the device. Such security features may comprise, for example, a security patch and security pattern equipped in the device. Information pertaining to security features of the device is then provided from the device and received by the security system (step S233). In step S235, information pertaining to the security features is stored in the database with the corresponding MAC address. In step S241, a security rule is then applied to the security feature. It is then determined whether the security feature provides adequate protection to the corresponding device (step S243), and if so, an IP address is assigned to the device for network access (step S25), otherwise the method proceeds to step S271. In step S26, a connection between the internal network and the device is established. If the security feature does not provide adequate protection as specified by the security rule, a request is sent to the device, requiring the device to upgrade the security features thereof in order to conform to the security rule (step S271). In step S273, a reply message sending from the device is received. In step S274, it is determined whether the device is to be upgraded according to the reply message received in step S273. If the device agrees to be upgraded, the method proceeds to step S275, otherwise the method ends. In step S275, the security feature of the device is upgraded according to the security rule. When the upgrade is accomplished, the method proceeds to step S26 to establish a connection between the device and the internal network.

Various embodiments, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. Some embodiments may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing embodiments of the invention. When implemented on a general-purpose processor, the program code combines with the processor to provide a unique apparatus that operates analogously to specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A network security system, comprising:
a monitoring device detecting a network message transmitted by a network device requesting access to a network; and
an authentication server identifying a security feature of the network device transmitting the detected network message, applying a security rule to the network message to determine whether the security feature provides adequate protection, and if so, permitting the network device to access the network.

2. The system of claim 1, wherein the network device is a network computer, a mobile phone, a pager, or a personal digital assistant (PDA).

3. The system of claim 1, wherein the network is a wired network, or a wireless network, or a combination thereof.

4. The system of claim 1, further comprising a storage device storing identification and security feature records of the network device.

5. The system of claim 1, wherein the authentication server requests from the network device information pertaining to identification and security features thereof.

6. The system of claim 1, wherein the authentication server requests the network device for information pertaining to a security patch installed therein.

7. The system of claim 1, wherein the authentication server requests the network device for information pertaining to a security pattern thereof.

8. The system of claim 1, wherein the authentication server further requests the network device to upgrade its security feature according to the security rule.

9. The system of claim 8, wherein the authentication server further denies network access to or by the network device when receiving a disagreement from the network device for upgrading security feature thereof.

10. The system of claim 8, wherein the authentication server further upgrades security feature of the device in order to conform to the security rule.

11. A method for managing network vulnerability, comprising
identifying a network message transmitted by a network device requesting access to a network;
identifying a security feature of the network device transmitting the detected network message; and
applying a security rule to the security feature to determine whether the security feature provides adequate protection to the network device, and if so, permitting network the device to access the network.

12. The method of claim 11, wherein the network device is a network computer, a mobile phone, a pager or a personal digital assistant (PDA).

13. The method of claim 11, further storing identification and security feature records of the network device.

14. The method of claim 11, further requesting the network device for identification information and security features thereof.

15. The method of claim 11, further requesting the network device for information pertaining to a security patch installed therein

16. The method of claim 11, further requesting the network device for information pertaining to a security pattern thereof.

17. The method of claim 11, further requesting the device to upgrade its security feature in order to conform to the security rule.

18. The method of claim 17, further denying the device for network access when receiving a disagreement therefrom to upgrade the security feature thereof.

19. The method of claim 18, further blocking a connection port corresponding to the device.

20. The method of claim 17, further upgrading the security feature of the device according to the security rule when receiving an agreement therefrom to upgrade the security feature thereof.
